(19) United States
(12) Patent Application Publication
(10) Pub. No.: US 2013/0318193 A1
(43) Pub. Date: Nov. 28, 2013

(54) METHOD AND APPARATUS FOR MANAGING CONTENT AND ASSOCIATED INFORMATION SOURCED FROM MULTIPLE PLATFORMS

(71) Applicants: Ari Koli, Helsinki (FI); Sami Mikael Puura, Helsinki (FI); Dominic Strowbridge, London (GB)

(72) Inventors: Ari Koli, Helsinki (FI); Sami Mikael Puura, Helsinki (FI); Dominic Strowbridge, London (GB)

(21) Appl. No.: 13/479,985

(22) Filed: May 24, 2012

(51) Int. Cl. G06F 15/16; G06F 15/167

(52) U.S. Cl. 709/213; 709/217

(57) ABSTRACT

An approach is provided for managing content and associated information sourced from multiple platforms. A dynamic information management platform determines a request to present one or more content items. The one or more content items include inventory for presenting associated information. The dynamic information management platform determines at least one platform from among a plurality of platforms based, at least in part, on the one or more content items, metadata associated with the one or more content items, or a combination thereof. The plurality of platforms is associated with at least one common service. The dynamic information management platform then determines the information associated with the one or more content items from the at least one platform in either an online or offline mode of operation.

### BACKGROUND

Service providers and device manufacturers (e.g., wireless, cellular, etc.) are continually challenged to deliver value and convenience to consumers by, for example, providing compelling network services. One area of development includes providing a service that can aggregate content from multiple service providers for playback in a common client. However, these multiple service providers may have different arrangements with other content platforms, providers, and/or services (e.g., advertising platforms) to provide the respective content (e.g., a video item, an audio item, a mobile application, etc.) and associated information (e.g., advertisements, related information inserts, etc.). In many cases, service providers use platform-specific clients to enforce or implement the arrangements or rules established between the service providers and the various platforms. Accordingly, service providers and device manufacturers face significant technical challenges to enabling access to such services via a common aggregation service that can adapt to the arrangements or rules of the multiple platforms for presentation on a single client in place of dedicated clients.

### Some Example Embodiments

Therefore, there is a need for an approach for managing content and associated information sourced from multiple platforms.

According to one embodiment, a method comprises determining a request to present one or more content items. The one or more content items include inventory for presenting associated information (e.g., advertising information or other information inserts). The method also comprises determining at least one platform from among a plurality of platforms based, at least in part, on the one or more content items, metadata associated with the one or more content items, or a combination thereof. The plurality of platforms is associated with at least one common service. The method further comprises determining the information associated with the one or more content items from the at least one platform.

According to another embodiment, an apparatus comprising at least one processor, and at least one memory including computer program code, the at least one memory and the computer program code configured to, with the at least one processor, cause, at least in part, the apparatus to determine a request to present one or more content items. The one or more content items include inventory for presenting associated information. The apparatus is also caused to determine at least one platform from among a plurality of platforms based, at least in part, on the one or more content items, metadata associated with the one or more content items, or a combination thereof. The plurality of platforms is associated with at least one common service. The apparatus is further caused to determine the information associated with the one or more content items from the at least one platform.

According to another embodiment, a computer-readable storage medium carrying one or more sequences of one or more instructions which, when executed by one or more processors, cause, at least in part, an apparatus to determine a request to present one or more content items. The one or more content items include inventory for presenting associated information. The apparatus is also caused to determine at least one platform from among a plurality of platforms based, at least in part, on the one or more content items, metadata associated with the one or more content items, or a combination thereof. The plurality of platforms is associated with at least one common service. The apparatus is further caused to determine the information associated with the one or more content items from the at least one platform.

According to another embodiment, an apparatus comprises means for determining a request to present one or more content items. The one or more content items include inventory for presenting associated information. The apparatus also comprises means for determining at least one platform from among a plurality of platforms based, at least in part, on the one or more content items, metadata associated with the one or more content items, or a combination thereof. The plurality of platforms is associated with at least one common service. The apparatus further comprises means for determining the information associated with the one or more content items from the at least one platform.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (including derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of managing content and associated information sourced from multiple platforms, according to one embodiment;

FIG. 2 is a diagram of a system 200 for dynamic management of advertising information across multiple advertisement serving platforms, according to one embodiment;

FIG. 3A is a diagram of the components of an information serving platform, according to one embodiment;

FIG. 3B is a diagram of the components of a client application, according to one embodiment;

FIG. 4 is a flowchart of a process for managing content and associated information sourced from multiple platforms, according to one embodiment;

FIG. 5 is a ladder diagram that illustrates a sequence of messages and processes used in an online mode of operation, according to one embodiment;

FIG. 6 is a ladder diagram that illustrates a sequence of messages and processes used in an offline mode of operation, according to one embodiment;

FIGS. 7A and 7B are diagrams of user interfaces used in the processes described with respect to FIGS. 1-6, according to one embodiment;

FIG. 8 is a diagram of hardware that can be used to implement an embodiment of the invention;

FIG. 9 is a diagram of a chip set that can be used to implement an embodiment of the invention; and

FIG. 10 is a diagram of a mobile terminal (e.g., handset) that can be used to implement an embodiment of the invention.

### DESCRIPTION OF SOME EMBODIMENTS

Examples of a method, apparatus, and computer program for managing content and associated information sourced from multiple platforms platform are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

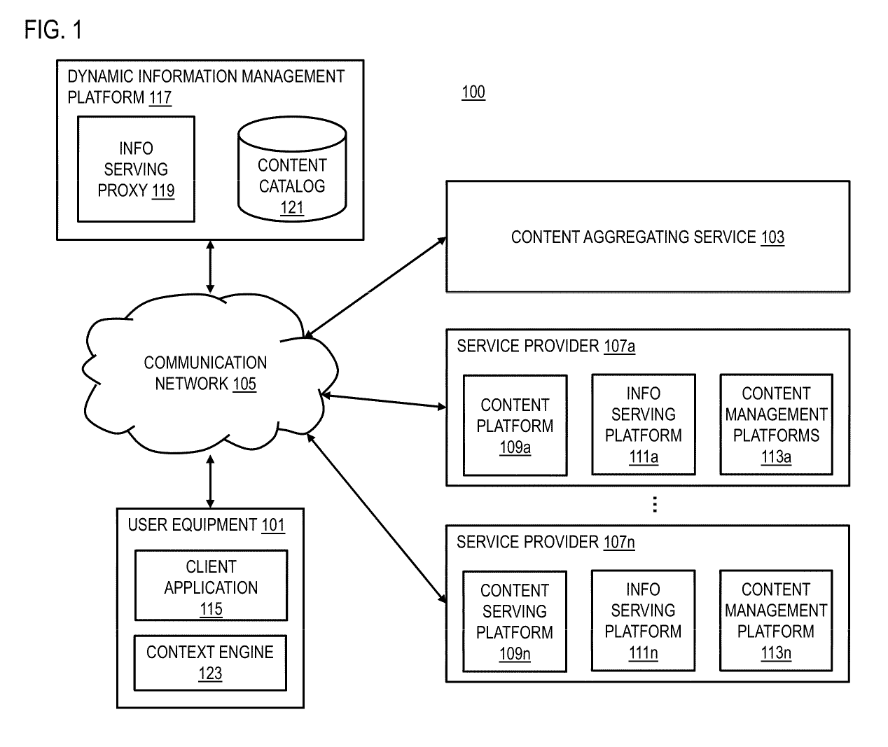

FIG. 1 is a diagram of a system capable of managing content and associated information sourced from multiple platforms, according to one embodiment. As noted previously, service providers and device manufacturers are increasingly interested in aggregating content services from multiple service providers in order facilitate ease of access to those services by end users. For example, video service providers provide a growing library of video content for access over the Internet. However, many of these service providers have relied on dedicated client applications or devices (e.g., dedicated media players) for access to their respective content. This practice has resulted in many users having to install multiple client applications for access to the services, thereby leading to a potentially cumbersome user experience. A user, for instance, would have to execute one client to access a first service to watch one video feed and then a second client to access a second service to watch another video feed. In one embodiment, a common video service or client that can access multiple content items from multiple service providers can ease the burden.

However, the common video service or client (e.g., particularly a mobile client running on a mobile platform with potentially limited resources) faces significant technical challenges to overcoming potential barriers to creating such a service. One barrier arises when service providers enable the capability to combine their content items with associated information (e.g., advertisements or other information inserts such as additional feeds, explanatory text, interactive information, etc.) provided by other platforms (e.g., information platforms, advertising platforms, etc.). Typically, service providers enter into agreements or other arrangements that dictate how and when such associated information (e.g., advertisements, etc.) are presented with the content. For example, information may be presented in breaks in the playback of content item, as overlays or banners across the content item, as clickable icons, etc. Because of the variety of ways that such information can be presented, there is often no standard or general approach to have client applications are to handle the integration of content playback with associated information, thereby resulting in the proliferation of dedicated client applications with their associated problems as discussed above. This, in turn, makes it very challenging to create universal or common players that are capable of aggregating and/or providing compatible access to a variety of services and/or service providers.

To address this problem, a system 100 of FIG. 1 introduces the capability to integrate content and related information from multiple service providers and information-serving platforms using a common service. In one embodiment, the integrated service is then available via a common client. In another embodiment, consumption of the integrated service, the content, and/or associated information from the various platforms can occur in either an online or offline mode of operation.

As shown in FIG. 1, the system 100 comprises a user equipment (UE) 101 having connectivity to a content aggregating service 103 over a communication network 105. In one embodiment, the content aggregating service 103 is an instance of dynamic content and related information (e.g., advertisements or other information inserts) management service that supports both online and offline content consumption. By way of example, the content aggregating service 103 provides connectivity to multiple service providers 107a-107n (also collectively referred to as service providers 107) to seamlessly provide access to the content available from the multiple service providers 107. In one embodiment, from the perspective of the service providers 107, the content aggregating service 103 enables the service providers 107 to manage what related information is inserted to the content that they are serving via the content aggregating service 103.

In one embodiment, the service providers 107a-107n each respectively have one or more of content serving platforms 109a-109n (also collectively referred to as content serving platforms 109), information serving platforms 111a-111n (also collectively referred to as information serving platforms 111), and/or content management platforms 113a-113n (also collectively referred to as content management platforms 113). In one embodiment, the content serving platforms 109 manage the streaming or downloading of content directly to a client application 115 executing at the UE 101. By way of example, some service providers 107 may manage the delivery of content on their own (e.g., via the content serving platforms 109), or they can manage the content delivery via third party content delivery networks (CDNs) (e.g., Akamai or Limelight).

In one embodiment, the client application 115 provides a user interface to access content from the service providers 107 via the content aggregating service 103. In a sample use case where the service providers 107 provide media content items (e.g., video, audio, books, etc.), the client application 115 includes the ability to browse and search for content from the service providers 107 in a common way. In one embodiment, the client application 115 includes a media player (e.g., player supporting any number of video and/or audio formats) which plays requested content as well as information inserts (e.g., advertising information) to be presented during the playback of the requested content.

In one embodiment, for content delivery to the client application 115, the service providers 107 may specify that information (e.g., advertisements or other information inserts) from one or more information serving platforms 111 be presented in and/or with the content. Accordingly, the information serving platforms 111 deliver information or other content that can be inserted into the content provided by the content serving platforms 109 at appropriate breaks or other designated space indicated in the content. By way of example, the breaks or other designated spaces in content provided by a service provider 107 can also be referred as “inventory” associated with the service provider 107. In one embodiment in which the breaks or spaces are for presenting advertising information, the inventory can be more specifically referred to as “advertising inventory.”

In one embodiment, the service provider 107 may be associated with or work with one or more information serving platforms 111 (e.g., advertising platforms) to fill available inventory in the content delivered to the client application 115. In another embodiment, the information serving platforms 111 provide user interfaces (e.g., graphical user interfaces (GUIs)) for managing what information should be inserted or associated with what content. The information serving platform 111 can also track and provide information related to the consumption or rates of consumption for of the information inserts (e.g., advertisements). In other words, any information about the user experience and interactions with the information inserts can be tracked and then reported to the relevant merchant/advertiser and/or publisher/developer. In this way, the merchants and publishers can conduct various analyses of the data to determine, for instance, the effectiveness or success of particular information inserts or advertisements.

In one embodiment, the information serving platforms 111 expose relevant interfaces (e.g., application programming interfaces (APIs)) to merchants/advertisers, publishers, etc. to target users for presentation of one or more information inserts (e.g., advertisements). In one embodiment, it is contemplated that the information serving platforms 111 may serve advertisements that are related to digital and/or physical goods and that the merchants/advertisers can be engaged in online commerce, offline commerce, or both.

In one embodiment, the service providers 107a-107n also are respectively associated with content management platforms 113. In one embodiment, the content management platforms 113 provide storage locations for where the service providers 107 maintain metadata and other information relating to the content they have to offer and the content's availability. For example, for television show content, such metadata and/or other information may include series and episode names, show descriptions, duration, age rating, availability dates, regional restrictions, cue points for inserting information (e.g., advertisements) from the information serving platforms 111, file locations for streamlining and downloading, and the like.

In one embodiment, the client application 115 interacts with the content aggregating service 103, the service providers 107, the content serving platforms 109, the information serving platforms 111, and/or the content management platforms 113 through the dynamic information management platform 117. In the example of FIG. 1, the dynamic information management platform 117 includes, at least in part, an information serving proxy 119 and a content catalog 121. In one embodiment, the information serving proxy 119 handles communications between the client application 115 and the dynamic information management platform 117 that relates to information inserts (e.g., advertisements) provided by the information serving platforms 111 to be presented in or with the content from the service providers 107. In one embodiment, the information serving proxy 119 determines which information serving platform 111 that has the information to be presented with a particular content item and then determines (e.g., by querying or interrogating) the identified information serving platform 111 for relevant information about the information (e.g., advertisements) to be presented with the content and then relaying the relevant information to the client application 115.

In one embodiment, the content catalog 121 of the dynamic information management platform 117 is the storage location for information about the available content from the different service providers 107 associate with the content aggregating service 103 and/or the dynamic information management platform 117. In one embodiment, information about the available inventory (e.g., advertising inventory) from the content of the service providers 107 also are stored in the content catalog 121. For example, for television show related content, advertising cue points (or cue points for insertion of other information such as related videos, social networking comments, reviews, etc.) may be specified at specific points throughout the duration of the content, or at relative points (e.g., start, midway, end, etc.). The types of presentations or transitions for the information inserts (e.g., advertisements) can also be specified in the content catalog 121. In embodiments, where the information inserts are interactive content, the URL or other location of the interactive content can be specified in the content catalog 121. In one embodiment, the content catalog 121 can be updated regularly, according to a schedule, on demand, etc. to ensure that it has up-to-date information from the service providers 107, the content serving platforms 109, the information serving platforms 111, and/or the content management platforms 113.

In one embodiment, the UE 101 also includes a context engine 123. The context engine 123 determines, for instance, the local context of UE 101 and any user thereof, such as local time, geographic position from a positioning system, ambient temperature, pressures, sound and light, and applications currently executing on UE 101, history of application usage, content currently being rendered on UE 101, user input through a user interface (UI), and/or other user interactions determined at the UE 101. The local context can then be used to determine the content and/or information inserts (e.g., advertisements) to present at the client application 115.

In one embodiment, the dynamic information management platform 117 enables both an online and an offline mode of operation for determining and retrieving information inserts (e.g., advertisement) for the client application 115. For example, when operating in an online mode, the dynamic information management platform 117 can determine what content is currently being accessed at the client application 115 and then retrieve the information inserts (e.g., advertisements) from the appropriate information serving platform 111 for real-time or substantially real-time playback. In an offline mode, the dynamic information management platform 117 can detect when a request to cache or download a content item is received at a service provider 107. Then, at the point of caching and/or downloading, the dynamic information management platform 117 can relay or provide the information inserts or information on where to obtain the information inserts at the time of downloading or caching. In this way, the client application 115 can retrieve and cache the appropriate insert for presentation when the associated content is viewed or accessed in the offline mode.

By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the UE 101, content aggregating service 103, the service providers 107, and the dynamic information management platform 117 communicate with each other and other components of the system 100 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

In one embodiment, the client application 115, the content aggregating service 103, the dynamic information management platform 117, and/or the service providers 107 interact according to a client-server model. According to the client-server model, a client process sends a message including a request to a server process, and the server process responds by providing a service (e.g., messaging, advertisements, etc.). The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

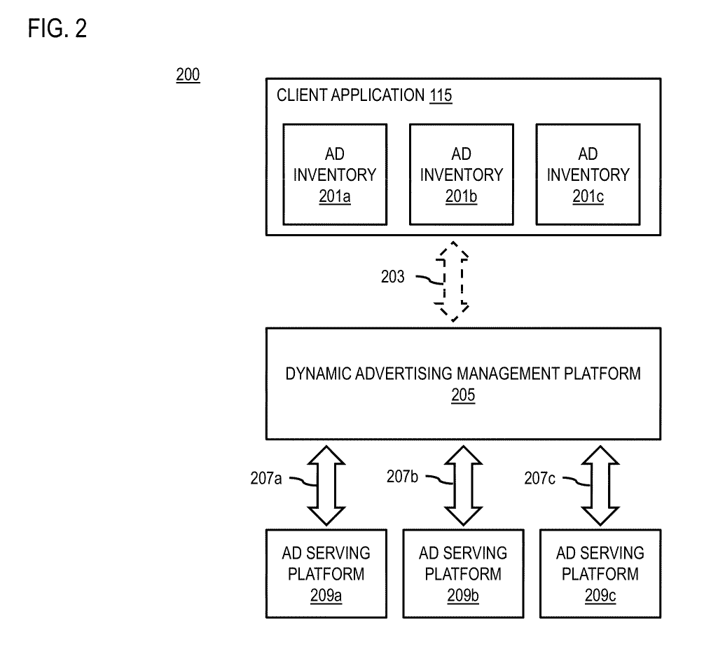

FIG. 2 is a diagram of a system 200 for dynamic management of advertising information across multiple advertisement serving platforms, according to one embodiment. As discussed above, one sample use case for the system 100 is for serving advertisements to a client application 115. In the context of advertising, a “publisher” can be a service provider 107 that includes advertising space or inventory in the respective service. As shown in FIG. 1, a client application 115 for the service includes advertisement inventory 201a-201c (also collectively referred to as advertising inventory 201) that represent the available breaks or spaces in the client application 115 and/or content presented via the client application 115.

In one embodiment, the client application 115 has connectivity 203 to a dynamic advertising management platform 205 that provide functions analogous to the dynamic information management platform 117 described above, but in the context of advertisement information as the primary information insert served. In this embodiment, the dynamic advertising management platform 205 enables connectivities 207a-207c to respective multiple advertising serving platform 209a-209c (also collectively referred to as advertising serving platforms 209). Similarly, the functions of the advertising serving platform 209 are analogous to the functions of the information serving platforms 111 described above, but in the context of advertising information.

In one embodiment, the system 200 enables functionality even when the connectivity 203 is not live or online (i.e., in an offline mode). In this offline case, the dynamic advertising management platform 205 determines the appropriate advertisements for a given content and provides information (e.g., links to the advertising information) to the client application 115. The client application 115 can then cache or download the identified advertising information at the time the content is cached or downloaded. In this way, the both the content and associated advertisements from the multiple advertisement serving platforms 209 are available for offline viewing at the client application 115.

Although various embodiments are discussed respect to, but are not limited to advertising information. It is contemplated that the various embodiments described herein are also applicable to any time of information that can be inserted into content from multiple information serving platforms 111. This information can include, for instance, related content that is available from the information serving platforms 111 that can supplement the content from the content serving platforms 109. For example, if a user if viewing a television show, the dynamic information management platform 117 can retrieve other video to play at appropriate breaks or inventory in the television show being viewed. Other content can also include related videos or content from social networking sites or other services (e.g., video reviews of the show, commentary from social networking friends, etc.).

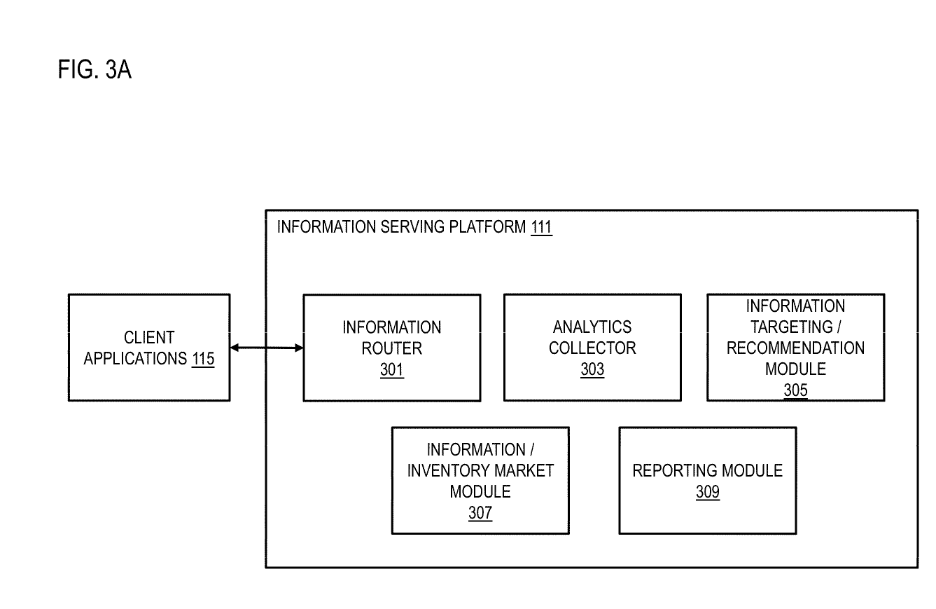

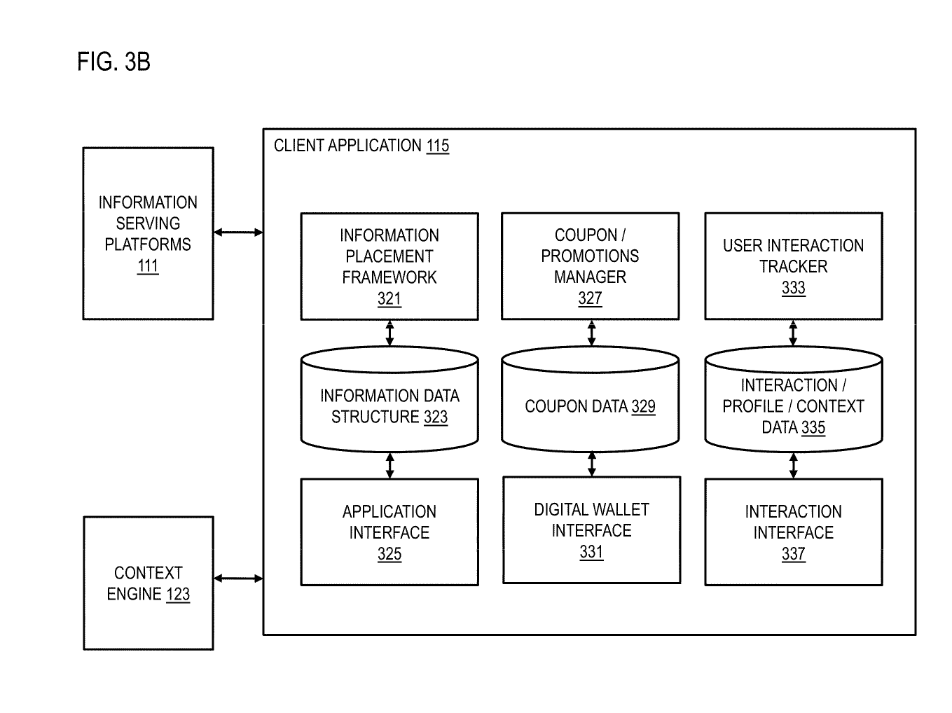

FIG. 3A is a diagram of the components of an information serving platform, according to one embodiment. By way of example, the information serving platform 111 includes one or more components for routing and managing information (e.g., advertisements or information inserts) for presentation to a user, and for performing the functions discussed with respects to the various embodiments described herein. The information serving platform 111 also includes components for reporting information insert-related use information to, for instance, the service provider 107, the dynamic information management platform 117, publishers, merchants, and other components of the system 100. It is contemplated that the functions of these components may be combined in one or more components or performed by other components of equivalent functionality. In this embodiment, the information serving platform 111 includes an information router 301. In one embodiment, the information router 301 processes requests for information inserts (e.g., advertisements) from, for instance, information serving proxy 119 and/or the client application 115. For example, the information router 301 enables routing to and integration with various advertisement providers and networks.

More specifically, the information router 301 feeds client applications 115 and/or the information serving proxy 119 with information inserts (e.g., advertisements) from any number of sources. In one embodiment, the information router 301 may route information inserts or advertisements based, at least in part, on context information (e.g., location, time, activity, etc.). In this way, the information router 301 can, for instance, apply country by country or region by region rules and/or policies for presenting information.

In one embodiment, the information router 301 can interact with an analytics collector 303 to track information insert (e.g., advertisement) related transactions (e.g., click through rates, advertisement buys, etc.) for reporting to end users, merchants, advertisers, publishers, and/or other users of the system 100. In the context of advertisements, these transactions can include, for instance, the costs and payments for placing advertisements, as well as metrics regarding user interactions with the advertisements. For example, if an advertisement includes a coupon or other discount information, the analytics collector 303 can collect information on the redemption of the coupons. In one embodiment, the analytics collector 303 can also collect context information, profile information, usage information, and the like from users to facilitate, e.g., targeted presentation of information, personalization of presented information, enriching of presented information or content, etc.

In one embodiment, the analytics collector 303 can also provide information to the information targeting/recommendation module 305. The targeting/recommendation module 305 can optimize the fulfillment of information insert requests by, for instance, characterizing the users associated with particular means (e.g., location-based or local searches, applications with in-application advertisement presentation, etc.) and then recommending which information inserts or advertisements are suited for which means. For example, the targeting/recommendation module 305 can receive criteria (e.g., from merchants/advertisers) for selecting a target audience (e.g., from a merchant or advertiser) and then recommend the means for presenting information or advertisements to the target audience.

In one embodiment, the targeting/recommendation module 305 can also interact with the information/inventory market module 307 to determine recommended values (e.g., monetary values) for publishers to request from presenting information such as advertisements through their products and for merchant/advertisers to offer to publishers to present information or advertisements to a target audience. In this way, publishers with products that have high numbers of users or users who are in targeted categories can maximize the value of their inventory of products and applications available for presenting advertisers. Similarly, merchants/advertisers who want to target a specific set of users (e.g., as defined by one or more criteria such as those based on user characteristics, usage history, etc.). In one embodiment, the information/inventory market module 307 can also mediate interactions between merchants/advertisers and publishers by, for instance, matching available inventory against information or advertisements to present. To facilitate this matching in the context of advertisements, the information/inventory market module 307 can support a real-time bidding system whereby advertisers can bid or otherwise obtain advertisement placement in publisher products or inventory based, at least in part, on the recommended offer and request values generated by the module 307.

In one embodiment, the information serving platform 111 includes a reporting module 309 for generating reports providing metrics associated with information presentation, user interactions with respect to the information inserts, effectiveness, yield, and other information generated by, for instance, the other modules of the information serving platform 111. For example, the reports can be based on operation of the any of the components of the information serving platform 111 including the analytics collector 303, the targeting/recommendation module 305, the information/inventory market module 307, etc.

FIG. 3B is a diagram of the components of a client application, according to one embodiment. By way of example, the client application 115 includes one or more components for receiving and presenting information or advertisements to a user. It is contemplated that the functions of these components may be combined in one or more components or performed by other components of equivalent functionality. In this embodiment, the client application 115 includes an information placement framework 321 and an information data structure 323. By way of example, the information placement framework 321 receives information inserts (e.g., advertising data) from, for instance, the information serving platforms 111 or the dynamic information management platform 117. The information inserts or advertising data (e.g., advertisements, information related to how and when to present advertisements, etc.) can then be stored or cached in the information data structure 323.

In other words, the information placement framework 321 serves as the entry and exit points for receiving information inserts or advertisements and then placing and/or handing off the information to the means for presenting the information (e.g., a media player component of the application 115). In one embodiment, the information placement framework 321 includes logic for displaying, converting (e.g., if necessary for presentation via a particular means), etc. the information inserts or advertisements.

In one embodiment, the information placement framework 321 can also relay context and/or profile information to information serving platform 111 to facilitate enriching of the information inserts or advertisements with personalized or other custom information. In this way, the information can be more specifically targeted and/or tailored to individual characteristics and/or preferences of a user.

As shown, the information placement framework 321 has connectivity to components external to the client application 115 via the application interface 325. For example, the application interface 325 facilitates communications between the client application 115 and other components of the system 100 within the UE 101 an external to the UE 101. In one embodiment, the application interface 325 exposes its interface via standard APIs (e.g., Qt, Web Runtime (WRT), Java, etc.).

In some embodiments, the information (e.g., advertisements or advertising data) include one or more coupons, discount information, promotions, offers, and other marketing information. Accordingly, the client application 115 includes a coupon/promotions manager 327 that can parse the coupon and other similar information from the information or advertisements for storage in the coupon data structure 329. In this way, the coupon, promotion, discount, etc. is available for immediate use by the user. In one embodiment, the coupon/promotions manager 327 can also interact with a digital wallet interface 331 to enable storing of the coupon or other discount in formation in a digital wallet or other storage external to the client application 115. As with the application interface 325, the digital wallet interface 331 can be exposed using standard APIs (e.g., Qt, WRT, Java, etc.).

In one embodiment, the client application 115 includes a user interaction tracker 333 for collecting, for instance, user interactions and/or responses to a presentation of the information inserts or advertisements served through client application 115. By way of example, the user interaction may include determining click through rates, conversion rates, etc. to facilitate determination of the effectiveness of the information or advertisements. In some embodiments, the user interaction tracker 333 may perform more sophisticated monitoring of user interactions such as tracking application use, coupon use, states changes, etc. associated with the UE 101, the applications or processes executing at the UE 101, or a combination thereof. In one embodiment, the user interaction tracker 333 can also monitor context changes, profile information, etc. associated with the UE 101 or a user associated with the UE 101 to, for instance, facilitate the customization and/or personalization of information inserts or advertisements.

In one embodiment, the information collected by the user interaction tracker 333 is stored in the interaction/profile/context data structure 335. In addition, the user interaction tracker can operate via the interaction interface 337 to retrieve interaction information from one or more applications or processes executing at the UE 101. The interaction interface 337 can also provide connectivity to the context engine 123 of the UE 101 to directly determine context information via, for instance, one or more sensors or sources of context information available at the UE 101.

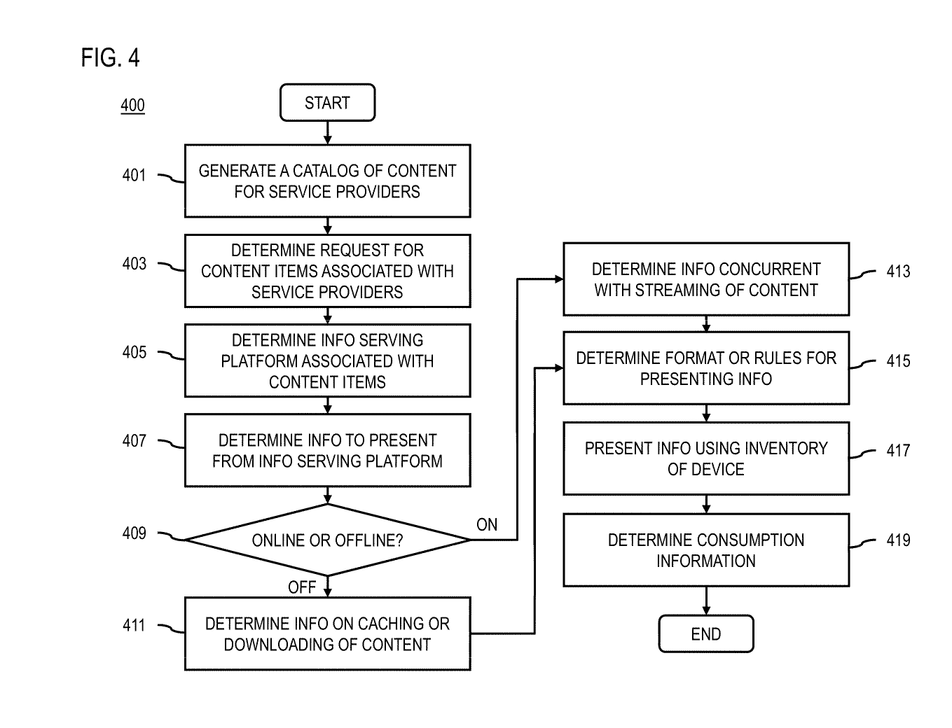

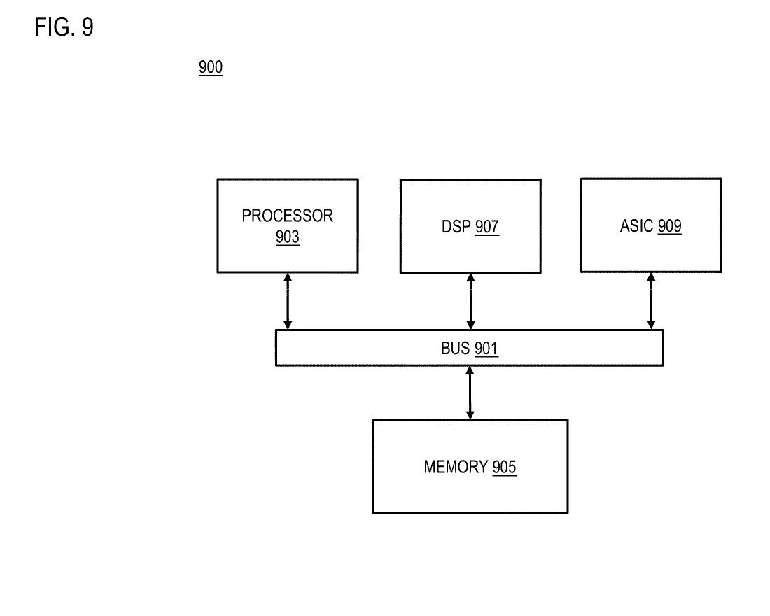

FIG. 4 is a flowchart of a process for managing content and associated information sourced from multiple platforms, according to one embodiment. In one embodiment, the dynamic information management platform 117 performs the process 400 and is implemented in, for instance, a chip set including a processor and a memory as shown FIG. 9. In addition or alternatively, all or a portion of the process 400 can be performed by the client application 115, the service provider 107, and/or the content aggregating service 103.

In step 401, the dynamic information management platform 117 causes, at least in part, a generation of at least one catalog 121 of one or more content items, one or more other content items, information (e.g., advertisements or information inserts) associated with the content items, other information, or a combination thereof associated with (1) at least one information serving platform 111 (e.g., an advertisement serving platform 209) from among a plurality of information serving platforms 111, (2) the plurality of platforms 111 as a whole, or (3) a combination thereof. In one embodiment, the one or more content items include inventory for presenting the associated information. In one embodiment, the plurality of platforms 111 is further associated with at least one common service (e.g., the content aggregating service 103).

In one embodiment, to generate the catalog 121, the dynamic information management platform 117 processes and/or facilitates a processing of metadata from the content management platforms 113 of the service providers 107. By way of example, the metadata describe, at least in part, both the content items and the inventory available for presenting associated information (e.g., advertising information) associated with the content items.

In step 403, the dynamic information management platform 117 determines a request to present one or more content items. The request, for instance, specifies presentation of the one or more content items using inventory available at a client device or client application 115. By way of example, to make this request, a user accesses the content aggregating service 103 via, for instance, the client application 115 to select content from any of the service providers 107 integrated into the content aggregating service 103 and/or the dynamic information management platform 117.

In step 405, the dynamic information management platform 117 determines at least one information serving platform 111 from among the plurality of information serving platforms 111 based, at least in part, on the one or more content items, metadata associated with the one or more content items, or a combination thereof. The dynamic information management platform 117 then determines or otherwise retrieves the information (e.g., advertisements or other information inserts) associated with the one or more content items from the determined at least one information serving platform 111 (step 407). For example, the dynamic information management platform 117 contacts (e.g., by interrogating or querying) the appropriate information serving platform 111 and gets a response that for instance provides the associated information (e.g., advertisements) or describes where, which, how many, etc. information inserts (e.g., advertisements) to retrieve. In one embodiment, this response is passed back to the client application 115 via the dynamic information management platform 117.

At step 409, the dynamic information management platform 117 determines whether client device or the client application 115 is operating in an online or offline mode. If operating in an offline mode (step 411), the dynamic information management platform 117 determines a request for a caching, a downloading, or a combination thereof of the one or more content items and then causes, at least in part, an initiation of the determination of the information from the at least one platform 111, a retrieval of the information, or a combination thereof based on the request. In one embodiment, the dynamic information management platform 117 determines to cache, to download, or a combination thereof the information at least substantially concurrently with the caching, the downloading, or a combination thereof of the one or more content items.

If the client application 115 is operating in an online mode (step 413), the dynamic information management platform 117 determines a request for a streaming of the one or more content items, and then causes, at least in part, an initiation of the determination of the information from the at least one platform, a presentation of the information, or a combination thereof at least substantially concurrently with the streaming.

Once the content and associated information are cached, downloaded, or streamed, the dynamic information management platform 117 optionally determines at least one format or rule for presenting the information based, at least in part, on the at least one device, the at least one platform 111, or a combination thereof (step 415). For example, the format may include a standardized format such as the Digital Video Ad Serving Template (VAST) format, or may include any other format compatible with the UE 101 or the client application 115. In one embodiment, the dynamic information management system may transcode the information or advertisement from a format provided by the information serving platform 111 to a format compatible with the client application 115. In one embodiment, the rules may specify criteria for targeting particular information inserts or advertisements to particular client applications 115 based, for instance, on a user's context, history, preferences, and the like.

The dynamic information management platform 117 then causes, at least in part, a presentation of the information using the inventory associated with at least one device or client application 115 of the at least one common service (e.g., content aggregating service 103) (step 417). For example, when a content item is selected, the content item is either played immediately (e.g., via streaming) or queued for download or caching. In one embodiment, the content plays or is provided directly from the service provider 107's content serving platform 109.

In the case of content being streamed in the context of advertisements, if an advertising break is specified in the metadata of the content, the content stream can be paused and the dynamic information management platform 117 can be interrogated for information inserts or advertisements to fill the particular inventory. If the content has been queued for download, a similar interrogation is made at the point of download so that appropriate information or advertisements can also be cached as described above.

In one embodiment, in the case of streaming, information inserts or advertisements are played directly between the client application 115 and the appropriate information serving platform 111. When the specified information inserts or advertisements have finished, the paused content resumes. In the download case, information inserts or advertisements are downloaded from the appropriate information serving platform 111. In one embodiment, the cache of information inserts or advertisements can be updated if any of the information is time sensitive or no longer valid.

In step 419, the dynamic information management platform 117 determines consumption information for the information, the one or more content items, or a combination thereof and causes, at least in part, a transmission of the consumption information to the at least one platform 111. By way of example, the consumption information can be directly reported to the information serving platforms 111 that are compatible (e.g., platforms 111 that are VAST compatible). For platforms 111 that are not compatible (e.g., platforms 111 that do not support VAST), the consumption information can be reported or accessed from the dynamic information management platform 117.

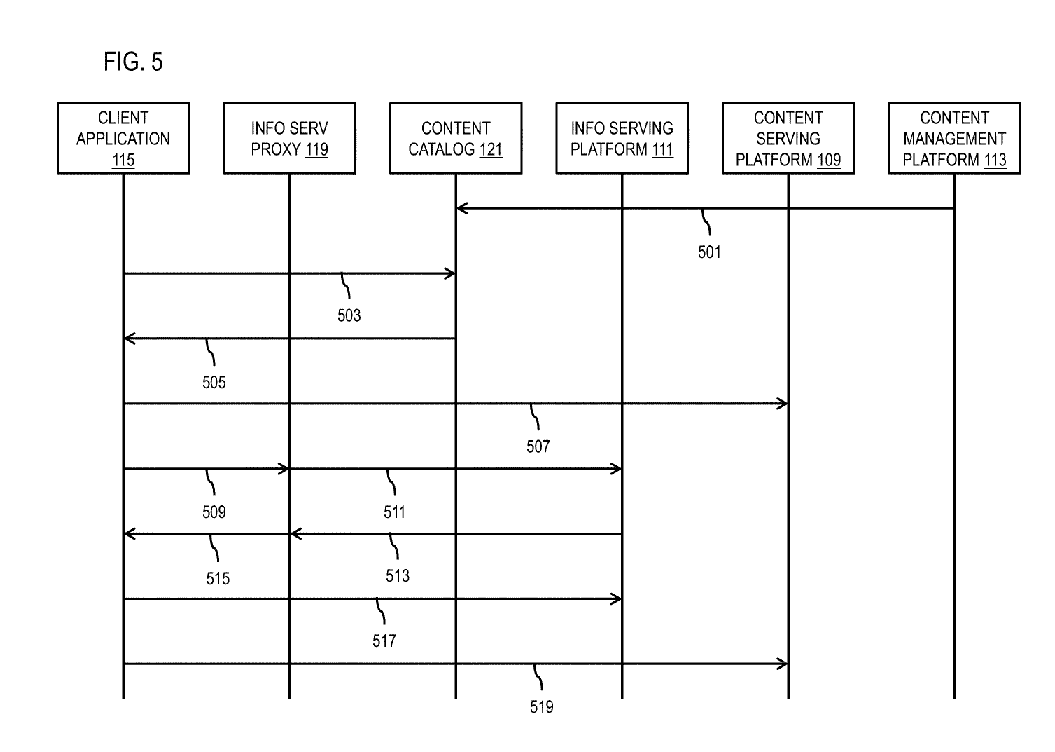

FIG. 5 is a ladder diagram that illustrates a sequence of messages and processes used in an online mode of operation, according to one embodiment. A network process is represented by a thin vertical line. A step or message passed from one process to another is represented by horizontal arrows. The processes represented in FIG. 5 are the client application 115, the information serving proxy 119, the content catalog 121, the information serving platform 111, the content serving platform 109, and the content management platform 113.

In step 501, a service provider 107 via the content management platform 113 sends regulate updates regarding the content items offered as well as the available inventory (e.g., advertisement inventory) associated with the content items to the content catalog 121. In step 503, a user browses the available content in the content catalog 121 via the client application 115. When a particular content item is selected for presentation or playback, the content catalog 121 passes relevant details about the content (e.g., a television show) and available inventory to the client application 115 (step 505).

In the online mode, the client application 115 accesses the content (e.g., the television show or other media content) and initiates playback by, for instance, streaming the content from the appropriate content serving platform 109 (step 507). In step 509, when an available inventory (e.g., an advertising break) is reached, the client application 115 signals the dynamic information serving proxy 119 what it is presenting or playing, where it has reached during playback, and/or other relevant parameters. The information serving proxy 119 then contacts the relevant information serving platform 111 requesting information about the relevant information inserts or advertisements (step 511).

In step 513, the information serving platform 111 gives a response (e.g., in VAST format) specifying the information inserts or advertisements and their locations to the information serving proxy 119. The information serving proxy 119 then relays the information to the client application 115 (step 515).

In step 517, the client application 115 plays or presents the information inserts or advertisements directly from the information serving platform 111. In one embodiment, the client application 115 can also provide consumption information or reports directly to the information serving platform 111 (e.g., in VAST format). When the information inserts or advertisements have finished, the content playback is resumed from where it was paused (step 519).

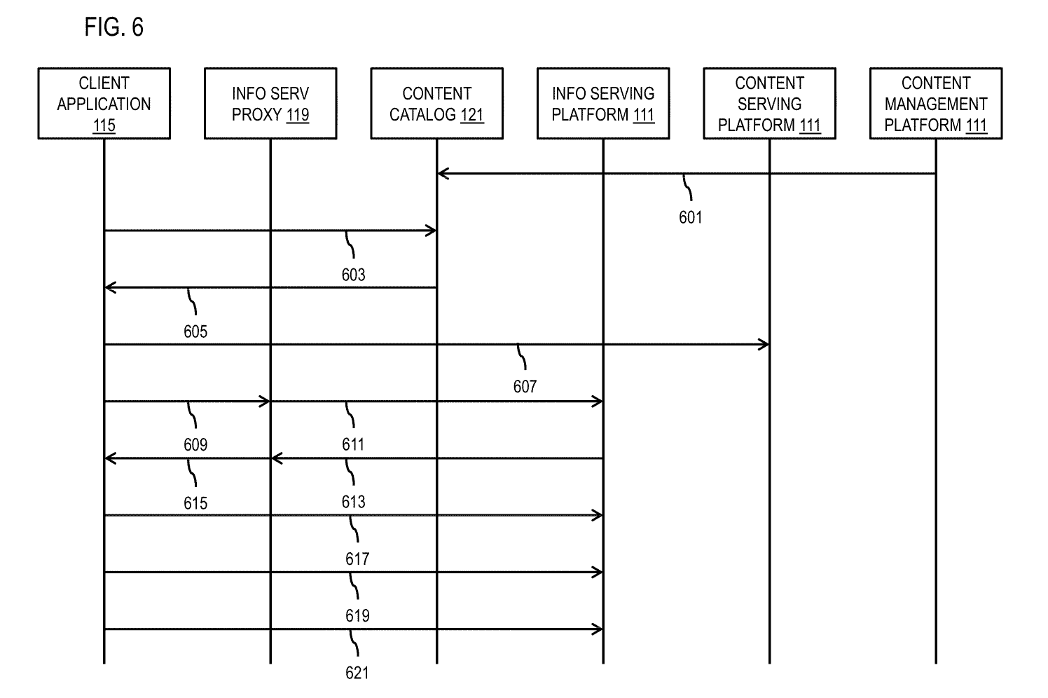

FIG. 6 is a ladder diagram that illustrates a sequence of messages and processes used in an offline mode of operation, according to one embodiment. A network process is represented by a thin vertical line. A step or message passed from one process to another is represented by horizontal arrows. The processes represented in FIG. 6 are the client application 115, the information serving proxy 119, the content catalog 121, the information serving platform 111, the content serving platform 109, and the content management platform 113.

In step 601, a service provider 107 via the content management platform 113 sends regulate updates regarding the content items offered as well as the available inventory (e.g., advertisement inventory) associated with the content items to the content catalog 121. In step 603, a user browses the available content in the content catalog 121 via the client application 115. When a particular content item is selected for presentation or playback, the content catalog 121 passes relevant details about the content (e.g., a television show) and available inventory to the client application 115 (step 605).

In the offline mode, rather than stream the selected content, the client application 115 downloads the content from the content serving platform 109 (step 607). During the download, the client application requests information inserts or advertisements for all breaks or inventory in the content (step 609). Accordingly, in step 611, the information serving proxy 119 contacts the relevant information serving platform 111 requesting information about the relevant information inserts or advertisements.

In step 613, the information serving platform 111 gives a response specifying the requested information inserts or advertisements and their locations to the information serving proxy 119. This information is then relayed to the client application 115 (step 615). Based on the information, the client application 115 downloads the information inserts or advertisements directly from the information serving platform 111 and caches them for playback later (step 617).

If any of the information inserts or advertisements is time sensitive and “expires” before the end user has watched the associated content item (e.g., a television show), the client application 115 can request a new information insert or advertisement from the original information serving platform 111 if the client application 115 goes online again (step 619). In one embodiment, if no replacement information insert or advertisement is available, then the client application 115 may omit the specified break.

When the downloaded content and associated information inserts have been played, the client application 115 can cache any consumption reports or information until the client device comes online again (step 621). As discussed previously, the consumption information or reports can be sent directly to the relevant information serving platform 111, or collected by the dynamic information management platform 117 as appropriate.

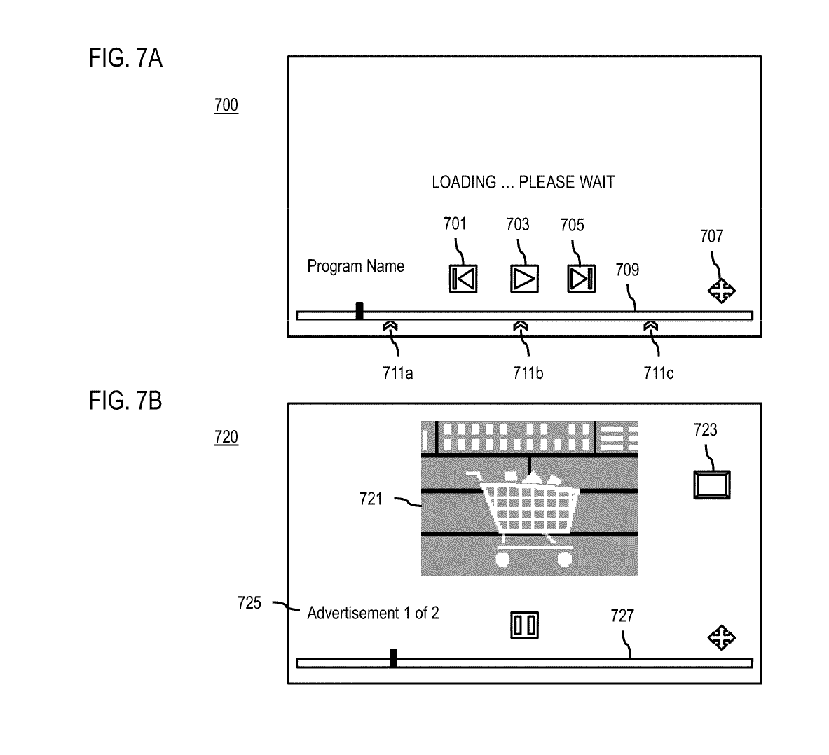

FIGS. 7A and 7B are diagrams of user interfaces used in the processes described with respect to FIGS. 1-6, according to one embodiment. More specifically, FIGS. 7A and 7B represent a user experience for playback video formatted information inserts or advertisements determined according to the various embodiments described herein. User interface 700 depicts a media playback screen of a client application 115 that is playing back selected content. In this case the content is loading from the content serving platform 109 as indicated.

In one embodiment, the user interface 700 provides several playback controls. For example, a single tap of the rewind button 701 enables the user to skip back ten seconds, and a long press on the rewind button 701 will continue rewinding in ten second jumps. The play button 703 toggles between play and pause, which stops playback. Similarly, a sign tap of the fast forward button 705 enables the user to skip forward ten seconds, and a long press will continue jumping ahead in 10 second steps.

The full screen button 707 will scale a video to fill the screen, and a second press will return the video to its original size. The progress bar 709 shows how much of the content has been played. Markers 711a-711c on the progress bar 709 indicate where advertising breaks or inventory are due. In one embodiment, fast forwarding past the markers 711a-711c can cause the breaks to be played immediately. Similarly, rewinding past the markers 711a-711c can cause the information insert or advertisement in the break to play again.

As shown in the user interface 720 of FIG. 7B, when an advertising break is reached, the content playback is paused and the information inserts or advertisements are requested from the relevant information serving platform 111. In one embodiment, the transition between the content playback and advertisement playback can be defined by each service provider 107 or broadcaster as one or more playback rules. For example, the transition can be a simple fade, a branded splash screen or another image. The advertisements 721 are then played as shown in the user interface 720.

In one embodiment, during playback of the advertisements 721, an interactive button 723 can be presented, allowing the user to open a URL, other application, etc. related to the playing advertisements 721. Playback of the advertisements 721 can be paused if the user selects the interactive button 723 to access the related content, and then resume on return to the client application 115.

As shown, the program name can be replaced with a message 725 indicating the number of advertisements 721 to be played. The progress bar 727 can show how far through the advertisements 721 have played.

The processes described herein for managing content and associated information sourced from multiple platforms may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

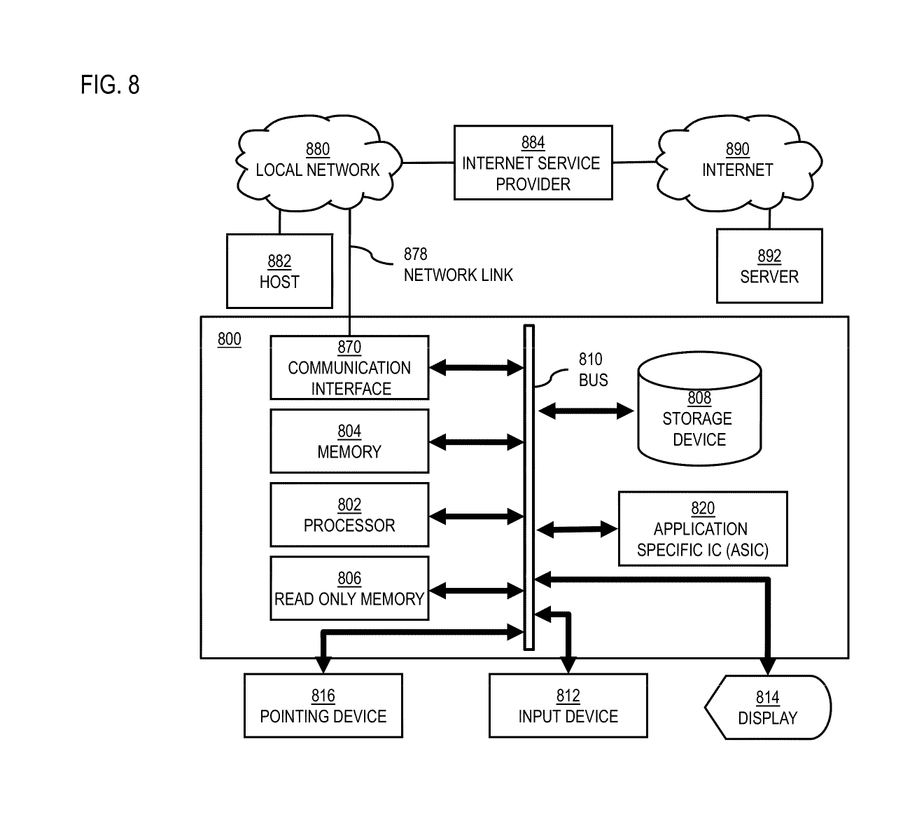

FIG. 8 illustrates a computer system 800 upon which an embodiment of the invention may be implemented. Although computer system 800 is depicted with respect to a particular device or equipment, it is contemplated that other devices or equipment (e.g., network elements, servers, etc.) within FIG. 8 can deploy the illustrated hardware and components of system 800. Computer system 800 is programmed (e.g., via computer program code or instructions) to manage content and associated information sourced from multiple platforms as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 800, or a portion thereof, constitutes a means for performing one or more steps of managing content and associated information sourced from multiple platforms.

A bus 810 includes one or more parallel conductors of information so that information is transferred quickly among devices coupled to the bus 810. One or more processors 802 for processing information are coupled with the bus 810.

A processor (or multiple processors) 802 performs a set of operations on information as specified by computer program code related to managing content and associated information sourced from multiple platforms. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or any other dynamic storage device, stores information including processor instructions for managing content and associated information sourced from multiple platforms. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or any other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for managing content and associated information sourced from multiple platforms, is provided to the bus 810 for use by the processor from an external input device 812, such as a keyboard containing alphanumeric keys operated by a human user, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT), a liquid crystal display (LCD), a light emitting diode (LED) display, an organic LED (OLED) display, a plasma screen, or a printer for presenting text or images, and a pointing device 816, such as a mouse, a trackball, cursor direction keys, or a motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of ASICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 105 for managing content and associated information sourced from multiple platforms.

The term “computer-readable medium” as used herein refers to any medium that participates in providing information to processor 802, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 808. Volatile media include, for example, dynamic memory 804. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 820.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system 800 can be deployed in various configurations within other computer systems, e.g., host 882 and server 892.

At least some embodiments of the invention are related to the use of computer system 800 for implementing some or all of the techniques described herein. According to one embodiment of the invention, those techniques are performed by computer system 800 in response to processor 802 executing one or more sequences of one or more processor instructions contained in memory 804. Such instructions, also called computer instructions, software and program code, may be read into memory 804 from another computer-readable medium such as storage device 808 or network link 878. Execution of the sequences of instructions contained in memory 804 causes processor 802 to perform one or more of the method steps described herein. In alternative embodiments, hardware, such as ASIC 820, may be used in place of or in combination with software to implement the invention. Thus, embodiments of the invention are not limited to any specific combination of hardware and software, unless otherwise explicitly stated herein.

The signals transmitted over network link 878 and other networks through communications interface 870, carry information to and from computer system 800. Computer system 800 can send and receive information, including program code, through the networks 880, 890 among others, through network link 878 and communications interface 870. In an example using the Internet 890, a server host 892 transmits program code for a particular application, requested by a message sent from computer 800, through Internet 890, ISP equipment 884, local network 880 and communications interface 870. The received code may be executed by processor 802 as it is received, or may be stored in memory 804 or in storage device 808 or any other non-volatile storage for later execution, or both. In this manner, computer system 800 may obtain application program code in the form of signals on a carrier wave.

Various forms of computer readable media may be involved in carrying one or more sequence of instructions or data or both to processor 802 for execution. For example, instructions and data may initially be carried on a magnetic disk of a remote computer such as host 882. The remote computer loads the instructions and data into its dynamic memory and sends the instructions and data over a telephone line using a modem. A modem local to the computer system 800 receives the instructions and data on a telephone line and uses an infra-red transmitter to convert the instructions and data to a signal on an infra-red carrier wave serving as the network link 878. An infrared detector serving as communications interface 870 receives the instructions and data carried in the infrared signal and places information representing the instructions and data onto bus 810. Bus 810 carries the information to memory 804 from which processor 802 retrieves and executes the instructions using some of the data sent with the instructions. The instructions and data received in memory 804 may optionally be stored on storage device 808, either before or after execution by the processor 802.

FIG. 9 illustrates a chip set or chip 900 upon which an embodiment of the invention may be implemented. Chip set 900 is programmed to manage content and associated information sourced from multiple platforms as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 900 can be implemented in a single chip. It is further contemplated that in certain embodiments the chip set or chip 900 can be implemented as a single “system on a chip.” It is further contemplated that in certain embodiments a separate ASIC would not be used, for example, and that all relevant functions as disclosed herein would be performed by a processor or processors. Chip set or chip 900, or a portion thereof, constitutes a means for performing one or more steps of providing user interface navigation information associated with the availability of functions. Chip set or chip 900, or a portion thereof, constitutes a means for performing one or more steps of managing content and associated information sourced from multiple platforms.

In one embodiment, the chip set or chip 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 900 includes merely one or more processors and some software and/or firmware supporting and/or relating to and/or for the one or more processors.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to manage content and associated information sourced from multiple platforms. The memory 905 also stores the data associated with or generated by the execution of the inventive steps.

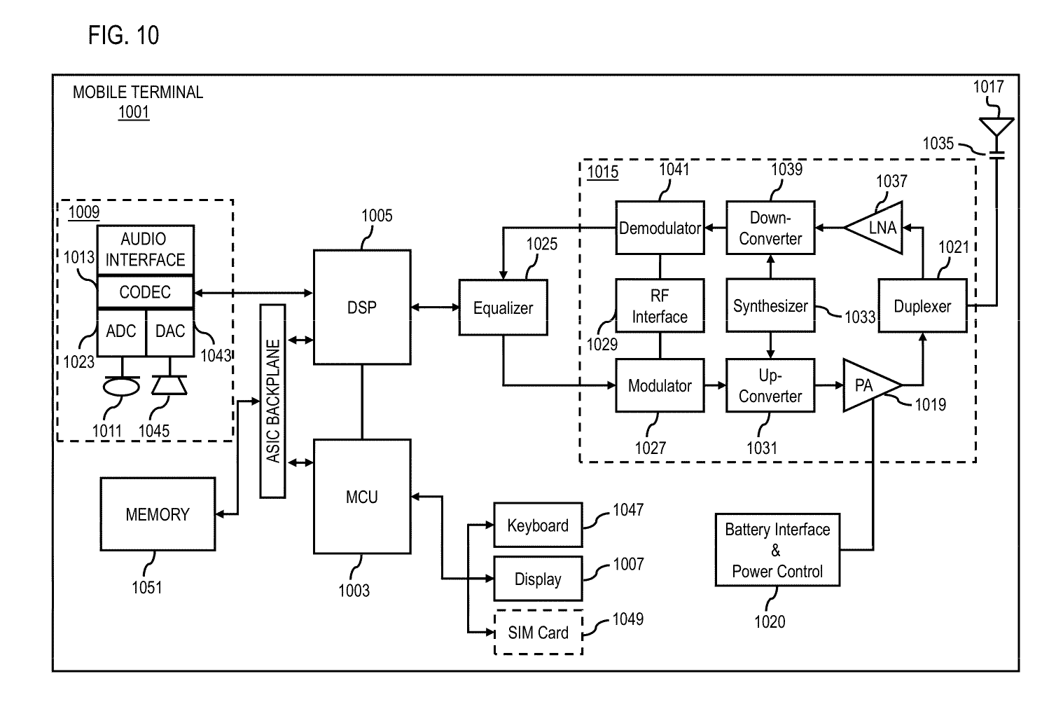

FIG. 10 is a diagram of exemplary components of a mobile terminal (e.g., handset) for communications, which is capable of operating in the system of FIG. 1, according to one embodiment. In some embodiments, mobile terminal 1001, or a portion thereof, constitutes a means for performing one or more steps of managing content and associated information sourced from multiple platforms. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile terminal functions that perform or support the steps of managing content and associated information sourced from multiple platforms. The display 1007 includes display circuitry configured to display at least a portion of a user interface of the mobile terminal (e.g., mobile telephone). Additionally, the display 1007 and display circuitry are configured to facilitate user control of at least some functions of the mobile terminal. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile terminal 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003 which can be implemented as a Central Processing Unit (CPU) (not shown).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile terminal 1001 to manage content and associated information sourced from multiple platforms. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the terminal. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile terminal 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable storage medium known in the art. The memory device 1051 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile terminal 1001 on a radio network. The card 1049 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
a request to present one or more content items, wherein the one or more content items include inventory for presenting associated information;
at least one determination at least one platform from among a plurality of platforms based, at least in part, on the one or more content items, metadata associated with the one or more content items, or a combination thereof, wherein the plurality of platforms is associated with at least one common service; and
at least one determination the information associated with the one or more content items from the at least one platform.

2. A method of claim 1, wherein the (1) data and/or (2) information and/or (3) at least one signal are further based, at least in part, on the following:
a presentation of the information using the inventory associated with at least one device that is a client of the at least one common service.

3. A method of claim 2, wherein the (1) data and/or (2) information and/or (3) at least one signal are further based, at least in part, on the following:
at least one format for the information based, at least in part, on the at least one device, the at least one platform, or a combination thereof,
wherein the presentation is based, at least in part, on the at least one format.

4. A method of claim 1, wherein the (1) data and/or (2) information and/or (3) at least one signal are further based, at least in part, on the following:
a request for a streaming of the one or more content items; and
an initiation of the determination of the information from the at least one platform, a presentation of the information, or a combination thereof at least substantially concurrently with the streaming.

5. A method of claim 1, wherein the (1) data and/or (2) information and/or (3) at least one signal are further based, at least in part, on the following:
a request for a caching, a downloading, or a combination thereof of the one or more content items;
an initiation of the determination of the information from the at least one platform, a retrieval of the information, or a combination thereof; and
at least one determination to cache, to download, or a combination thereof the information at least substantially concurrently with the caching, the downloading, or a combination thereof of the one or more content items.

6. A method of claim 5, wherein the (1) data and/or (2) information and/or (3) at least one signal are further based, at least in part, on the following:
an initiation of the request for the caching, the downloading, or a combination thereof of the one or more content items based, at least in part, on a determination of an offline status or an online status of at least one client device.

7. A method of claim 1, wherein the (1) data and/or (2) information and/or (3) at least one signal are further based, at least in part, on the following:
at least one determination of one or more rules for presenting the information based, at least in part, on the at least one platform.

8. A method of claim 1, wherein the (1) data and/or (2) information and/or (3) at least one signal are further based, at least in part, on the following:
at least one determination of consumption information for the information, the one or more content items, or a combination thereof; and
a transmission of the consumption information to the at least one platform.

9. A method of claim 1, wherein the (1) data and/or (2) information and/or (3) at least one signal are further based, at least in part, on the following:
a generation of at least one catalog of the one or more content items, one or more other content items, the information, other information or a combination thereof associated with the at least one platform, the plurality of platforms, or a combination thereof.

10. A method of claim 1, wherein the one or more content items, the information, or a combination thereof are associated with at least one of a plurality service providers, and wherein the plurality of service providers is associated with the at least one common service, the at least one platform, the plurality of platform, or a combination thereof.

11. An apparatus comprising:
at least one processor; and
at least one memory including computer program code for one or more programs,
the at least one memory and the computer program code configured to, with the at least one processor, cause the apparatus to perform at least the following,
determine a request to present one or more content items, wherein the one or more content items include inventory for presenting associated information;
determine at least one platform from among a plurality of platforms based, at least in part, on the one or more content items, metadata associated with the one or more content items, or a combination thereof, wherein the plurality of platforms is associated with at least one common service; and
determine the information associated with the one or more content items from the at least one platform.

12. An apparatus of claim 11, wherein the apparatus is further caused to:
cause, at least in part, a presentation of the information using the inventory associated with at least one device that is a client of the at least one common service.

13. An apparatus of claim 12, wherein the apparatus is further caused to:
determine at least one format for the information based, at least in part, on the at least one device, the at least one platform, or a combination thereof,
wherein the presentation is based, at least in part, on the at least one format.

14. An apparatus of claim 11, wherein the apparatus is further caused to:
determine a request for a streaming of the one or more content items; and
cause, at least in part, an initiation of the determination of the information from the at least one platform, a presentation of the information, or a combination thereof at least substantially concurrently with the streaming.

15. An apparatus of claim 11, wherein the apparatus is further caused to:
determine a request for a caching, a downloading, or a combination thereof of the one or more content items;
cause, at least in part, an initiation of the determination of the information from the at least one platform, a retrieval of the information, or a combination thereof; and
determine to cache, to download, or a combination thereof the information at least substantially concurrently with the caching, the downloading, or a combination thereof of the one or more content items.

16. An apparatus of claim 15, wherein the apparatus is further caused to:
cause, at least in part, an initiation of the request for the caching, the downloading, or a combination thereof of the one or more content items based, at least in part, on a determination of an offline status or an online status of at least one client device.

17. An apparatus of claim 11, wherein the apparatus is further caused to:
determine one or more rules for presenting the information based, at least in part, on the at least one platform.

18. An apparatus of claim 11, wherein the apparatus is further caused to:
determine consumption information for the information, the one or more content items, or a combination thereof; and
cause, at least in part, a transmission of the consumption information to the at least one platform.

19. An apparatus of claim 11, wherein the apparatus is further caused to:
cause, at least in part, a generation of at least one catalog of the one or more content items, one or more other content items, the information, other information or a combination thereof associated with the at least one platform, the plurality of platforms, or a combination thereof.

20. An apparatus of claim 11, wherein the one or more content items, the information, or a combination thereof are associated with at least one of a plurality service providers, and wherein the plurality of service providers is associated with the at least one common service, the at least one platform, the plurality of platform, or a combination thereof.

21-48. (canceled)
